(19) United States
(12) Patent Application Publication
(10) Pub. No.: US 2008/0307721 A1
(43) Pub. Date: Dec. 18, 2008

(54) Anchoring Systems And Related Methods

(76) Inventor: Jeffrey Todd Schultz, Broomfield, CO (US)

Correspondence Address: LATHROP & GAGE LC, 4845 PEARL EAST CIRCLE, SUITE 300, BOULDER, CO, 80301, US

(21) Appl. No.: 12/135,681

(22) Filed: Jun. 9, 2008

Related U.S. Application Data
(60) Provisional application No. 60/943,663, filed on Jun. 13, 2007.

(51) Int. Cl. E02D 5/74; F16M 13/00; E04B 1/00

(52) U.S. Cl. 52/157; 248/545; 52/741.15

(57) ABSTRACT

In one embodiment, an anchoring system includes a first member and a second member. The first member includes a stem and a helix fixedly attached to the stem and configured to penetrate and lodge into ground. The second member couples to the first member and secures the anchoring system into the ground. A third member optionally couples to the stem of the first member and provides an attachment fixture for coupling an object to the anchoring system.

### RELATED APPLICATIONS

This application claims the benefit of priority to U.S. Provisional Patent Application Ser. No. 60/943,663, filed Jun. 13, 2007, and is incorporated by reference herein.

### BACKGROUND

Traffic sign, real estate sign, lawn furniture, and decorative object theft are often expensive and inconvenient, and can sometimes be dangerous. Most often the perpetrators consider their actions to be pranks. However, for property owners, business owners and government authorities, these pranks are costly and hazardous. Such behavior may be discouraged by making removal of the signs, furniture and decorative objects from the ground more difficult.

### SUMMARY

In one embodiment, an anchoring system includes a first member and a second member. The first member includes a stem and a helix fixedly attached to the stem. The helix is configured to penetrate and lodge into ground. The second member couples to the first member and secures the anchoring system into the ground.

In one embodiment, a method for installing an anchoring system includes coupling a second member to a first member, using the second member as a handle for guiding a portion of the first member into ground and securing the second member into the ground.

In one embodiment, a method for locking an object to an anchoring system includes coupling a second member to a first member having at least one locking orifice, using the second member as a handle for guiding a portion of the first member into ground, securing the second member into the ground, locking a third member to the at least one locking orifice of the first member and locking an object to the third member.

### BRIEF DESCRIPTION OF THE FIGURES

FIG. 1 shows one exemplary anchoring system, according to an embodiment.

FIG. 2 shows a side plan view of a first member of an anchoring system, according to an embodiment.

FIGS. 3A-D show perspective views of a second member of an anchoring system, according to multiple embodiments.

FIG. 4 shows one exemplary assembled anchoring system, according to an embodiment.

FIG. 5 shows one exemplary anchoring system including a third member, according to an embodiment.

FIGS. 6A-D show perspective views of a third member of an anchoring system, according to multiple embodiments.

FIG. 7 shows an exemplary method for installing an anchoring system, according to an embodiment.

FIG. 8 shows an exemplary method for locking an object to an anchoring system, according to an embodiment.

### DETAILED DESCRIPTION OF THE FIGURES

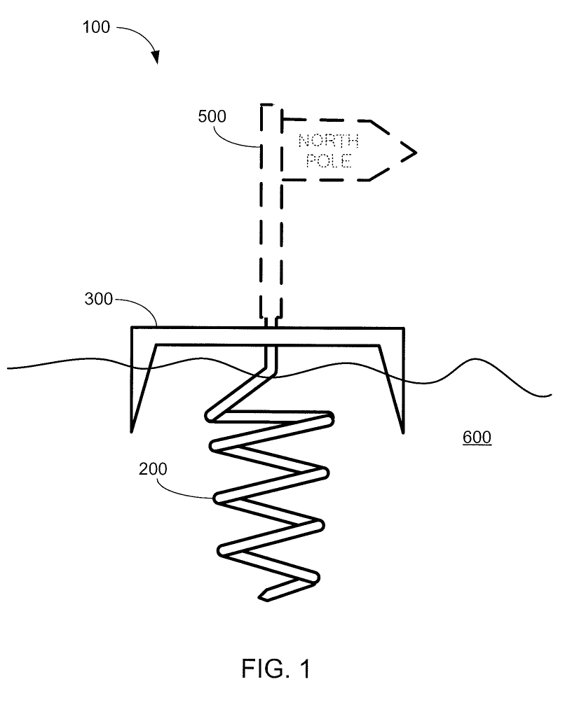

FIG. 1 shows one exemplary anchoring system 100. Anchoring system 100 includes a first member 200 and a second member 300. Anchoring system 100 is suitable for fastening an object 500, such as a sign, to ground 600, as described in more detail below.

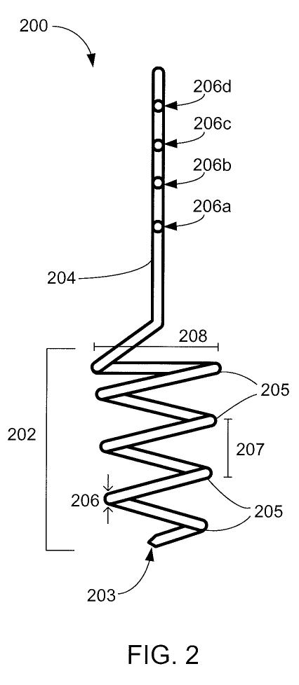

FIG. 2 shows a side plan view of first member 200 of anchoring system 100. First member 200 includes a helix 202 fixedly attached to a stem 204. First member 200 may be driven into the ground (e.g., ground 600 of FIG. 1) by guiding a pointed end 203 of helix 202 into ground 600 and rotating helix 202 about a longitudinal axis of stem 204, thereby entwining helical members 205 with soil and drawing first member 200 into the ground. Helix 202 may vary in length, material diameter 206, helical member spacing 207 and helix diameter 208 depending upon the requirements of a particular installation into ground 600.

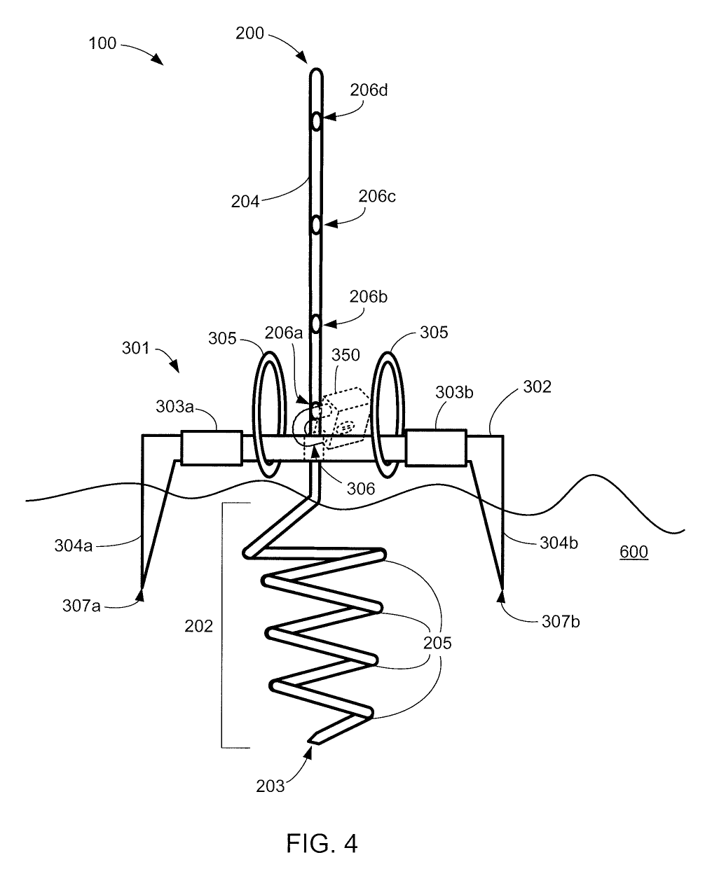

A locking orifice 206 may be formed through stem 204 at one or more distances from helix 202. Multiple locking orifices 206a, 206b, 206c and 206d allow a lock (350, FIG. 4B) to be fastened to stem 204 at select locations.

In one embodiment, a shaft of object 500 (FIG. 1) contains one or more pre-drilled holes that align with one or more locking orifices 206 of stem 204. A lock may be inserted through both a pre-drilled hole and locking orifice 206 to secure object 500 to anchoring system 100. Overlap of the shaft of object 500 and stem 204 may be implemented, as shown in FIG. 1, when the shaft forms a cavity that accepts stem 204. In an alternate embodiment, stem 204 may form a cavity configured to accept the shaft of object 500.

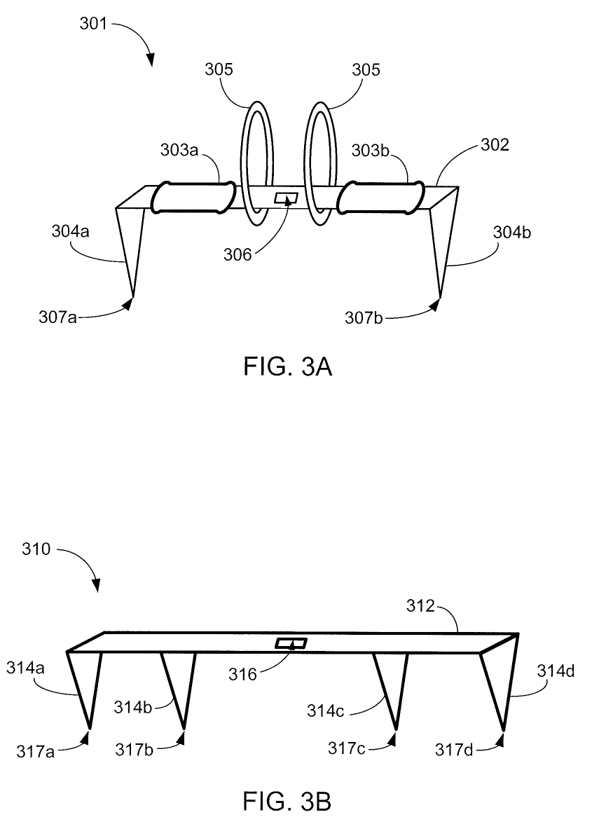

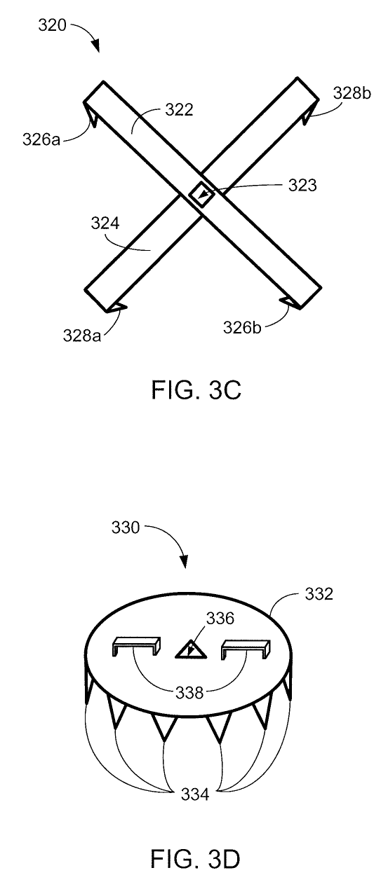

FIG. 3A shows a perspective view of second member 301 according to one embodiment. Second member 301 includes a horizontal bar 302 having a substantially planar bottom surface that comes into contact, or proximity, with the surface of ground 600. Two protrusions 304a and 304b are disposed substantially perpendicularly to horizontal bar 302. Each of protrusions 304a and 304b forms a point 307a and 307b, respectively, for penetrating ground 600. An aperture 306 is formed in the center of horizontal bar 302, and is configured to receive stem 204 of first member 200. Aperture 306 may be of any shape or size that is suitable for receiving stem 204. For example, a square shaped aperture 306 may be formed in horizontal bar 302 to receive a square stem 204.

Horizontal bar 302 may include grips 303a and 303b disposed on opposing sides of aperture 306. Grips 303a and 303b may for example be fabricated from metal, plastic, or rubber, and may be textured to provide increased friction for effective gripping. At least one strap 305 may attach to horizontal bar 302 for assisting with removal of second member 301 from ground 600.

FIG. 3B shows one exemplary second member 310 having a horizontal bar 312 including a plurality of protrusions 314a-314d disposed substantially perpendicularly to horizontal bar 312. Protrusions 314a-314d have points 317a-317d that facilitate piercing of ground 600. Horizontal bar 312 forms an aperture 316 that is configured to receive stem 204 of first member 200. Second member 310 may also include grips (e.g., grips 303a and 303b of FIG. 3A) and/or one or more straps (e.g., straps 305 of FIG. 3A) for assisting with installation and removal of anchoring system 100.

In one embodiment, a second member 320 includes two horizontal bars 322 and 324 that cross each other to form an “X”, as shown in FIG. 3C. Horizontal bars 322 and 324 may, for example, be soldered together or molded/cast as a single piece. Alternatively, horizontal bars 322 and 324 may be essentially the same as horizontal bar 301, and disposed in an X configuration by an end user. Horizontal bars 322 and 324 are each shown with two protrusions 326a, 326b and 328a, 328b, where the protrusions are disposed substantially perpendicularly to horizontal bars 322 and 324. It will be appreciated that additional protrusions, as shown in FIG. 3B, may be present. An aperture 323, or two overlapping apertures, is/are formed in the center of the X configuration. The X configuration of second member 320 may provide increased stability for an object (e.g., object 500 of FIG. 1) mounted to an anchoring system utilizing second member 320 as compared to an anchoring system employing a single horizontal bar.

FIG. 3D shows an exemplary second member 330 formed as a circular disc 332 having multiple protrusions 334. A circular configuration of second member 330 with multiple protrusions 334 encircling a perimeter and/or interior of disc 332 may serve to increase stability of an anchoring system utilizing second member 330 as compared to anchoring systems employing a single or double horizontal bar. Second member 330 may include grips 338 for assisting with the installation and removal of second member 330. For example, during installation, a user may couple second member 330 to stem 204 of first member 200, then take hold of grips 338 disposed on opposing sides of aperture 336 to rotate helix 202 of first member 200 into ground 600.

It will be appreciated that second member 300, 301, 310, 320, 330 may be configured in a variety of shapes and arrangements that are not explicitly illustrated, but which nevertheless fall within the scope of the present disclosure.

In one embodiment, protrusions (e.g., protrusions 304a and 304b) may be detachable from a horizontal bar (e.g., horizontal bar 302). For example, the detachable protrusions may vary in length and/or size for selectively coupling with a horizontal bar to meet the requirements of a particular installation. In another embodiment, protrusions may be hinged to a horizontal bar, and folding of the hinged protrusions may for example provide for safe and efficient transport and packaging.

FIG. 4 shows one exemplary assembled anchoring system 100. Stem 204 of first member 200 is disposed within aperture 306 of second member 301. Helix 202 and protrusions 304a and 304b are at least partially embedded in ground 600. A lock 350 may optionally be inserted into a locking orifice 206 disposed above second member 301. Lock 350 and helix 202 prevent the upward movement that is necessary to separate second member 301 from ground 600. At the same time, protrusions 304a and 304b prevent rotation of anchoring system 100 necessary to remove helix 202 from ground 600.

It will be appreciated that rotation of anchoring system 100 may be advantageously hindered or prevented by the use of a non-cylindrical stem 204. Further, second member 301 shall contain at least one protrusion that is configured to be embedded into ground 600 to a depth of between 3-18 inches, preferably 4-12 inches, more preferably 6-10 inches.

Anchoring system 100 is removed from ground 600 by, first, unfastening lock 350 and releasing the lock from locking orifice 206. Straps 305 may then be used to pull second member 301 in an upward direction away from ground 600. Once protrusions 304a and 304b clear the ground, second member 301 may be used as a handle (e.g., using grips 303a and 303b) to rotate first member 200 in a direction opposite the direction used to insert first member 200 into ground 600.

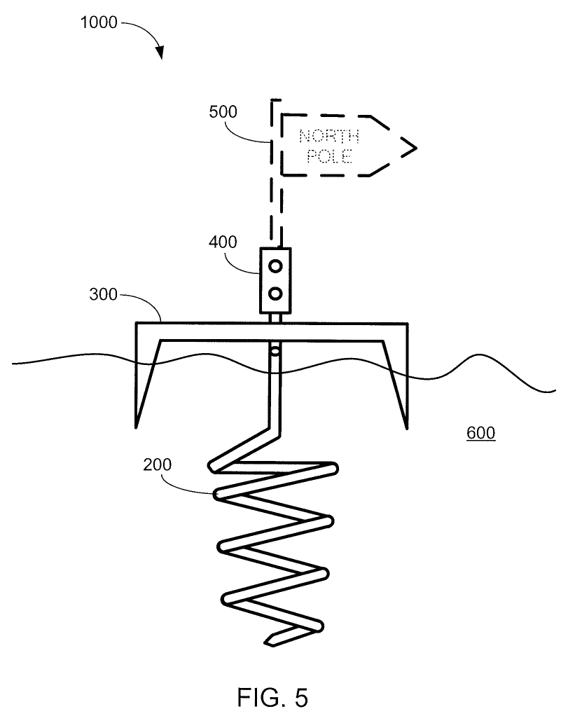

In one embodiment, shown in FIG. 5, an anchoring system 1000 may include a third member 400 that acts as an adapter for securing an object 500 such as a sign, a boat, a bike, or the like to anchoring system 100.

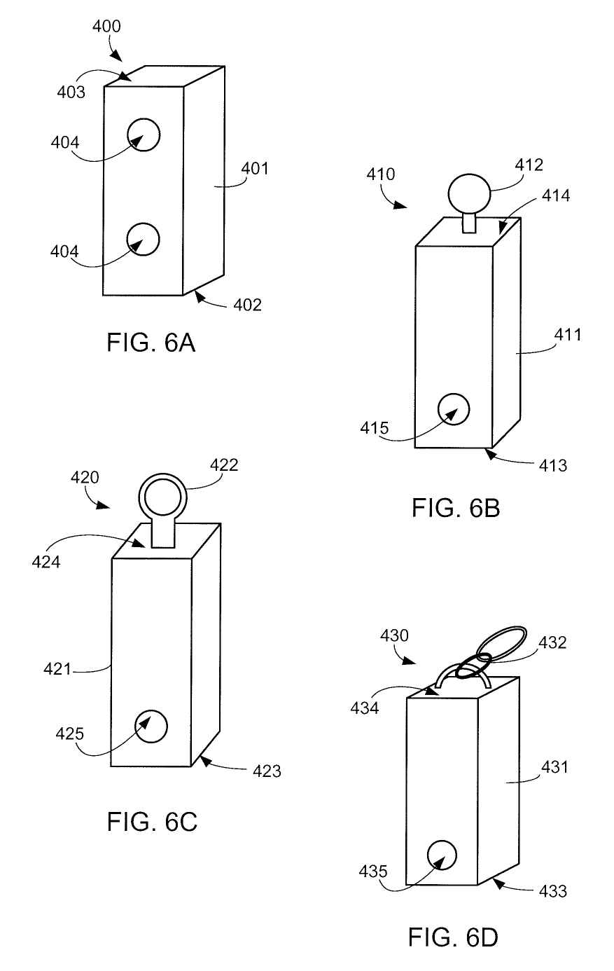

FIG. 6A shows a perspective view of third member 400 according to one embodiment. Third member 400 includes a body 401 and a securing feature such as an attachment orifice 404. Third member 400 attaches to anchoring system 100 to secure an object, such as object 500 of FIG. 1, to the anchoring system. Body 401 forms a channel that may receive stem 204 through an open end 402 or 403. Thus the shape of body 401 depends upon the shape of stem 204. Attachment orifice 404 may align with one or more locking orifices 206 and may receive a lock (e.g., lock 350) that secures third member 400 to anchoring system 100. Stem 204 does not occupy the entire cavity of body 401. Therefore, an open end 402 or 403 may receive object 500, and a second attachment orifice 404 may be aligned with a pre-drilled hole of object 500. A second lock may be used to secure object 500 to third member 400. As shown, third member 400 includes two attachment orifices 404; it will, however, be appreciated that third member 400 may include more than two attachment orifices.

FIG. 6B shows a perspective view of third member 410 according to one embodiment. Third member 410 is suitable for securing an object (e.g., object 500 of FIG. 1) to anchoring system 100. Third member 410 includes a body 411 and a securing feature such as an attachment fixture 412. Body 411 is hollow and forms an open end 413 and a closed end 414. A channel, formed within body 411, receives stem 204. An attachment orifice 415 may align with a locking orifice 206 of stem 204 and accept a lock (e.g., lock 350). Attachment fixture 412 is fixedly attached to closed end 414 so that an object may be fastened to third member 400. For example, FIG. 6B shows attachment fixture 412 as a ball hitch that may secure a trailer, a boat, lawn furniture, or the like to anchoring system 100.

It will be appreciated that changes may be made to attachment fixture 412 without departing from the scope hereof. For example, in one embodiment, FIG. 6C shows an attachment fixture 422 as a ring hitch. Attachment fixture 422 is configured to receive a chain or a lock to fasten an object (e.g., object 500 of FIG. 1) to anchoring system 100. Attachment fixture 422 is fixedly attached to a closed end 424 of body 421 of third member 420. A channel, formed within body 421, receives stem 204 through open end 423. An attachment orifice 425 may align with a locking orifice 206 and accept a lock (e.g., lock 350).

FIG. 6D shows attachment fixture 432 as a chain according to one embodiment. Body 431 forms an open end 433 and a closed end 434 with an attachment fixture 432 fixedly attached to closed end 434. Body 431 may include a channel, formed within body 431, for receiving stem 204. An attachment orifice 435 may align with a locking orifice 206 and receive a lock for securing an object (e.g., object 500 of FIG. 1) to anchoring system 100.

It will be appreciated that changes may be made to anchoring system 100, 1000 without departing from the scope hereof. For example, in one embodiment, anchoring system 100, 1000 includes or is integrally formed with a locking mechanism. The locking mechanism may, for example, be a U-bolt lock (e.g., lock 350) or a cylinder lock having one or more pins or deadbolts for engaging stem 204 and/or one or more locking orifices 206 and/or one or more attachment orifices 404. In another embodiment, anchoring system 100, 1000 may be large enough to anchor a leg of an oil rig to the ocean floor, thereby preventing the rig from becoming unbalanced and potentially flipping.

The above-described anchoring system components may be fabricated, for example, from one or more materials selected from metals, metal alloys (e.g., stainless steel), plastics, rubber, carbon fiber, wood, ceramics and combinations thereof.

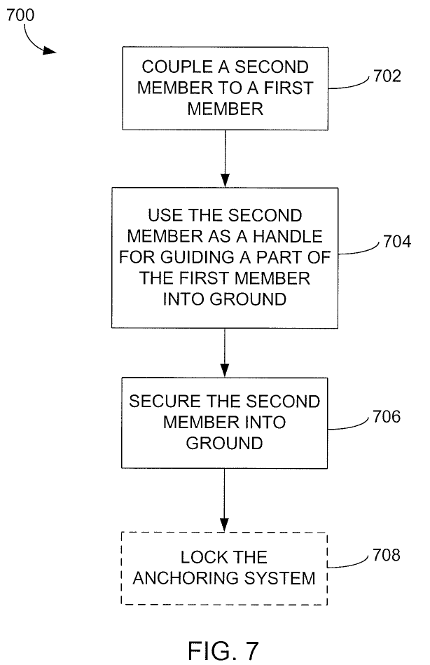

FIG. 7 shows a method 700 for assembling anchoring system 100, and optionally locking anchoring system 100. Method 700 starts with step 702. In step 702 second member 300 is coupled to first member 200 by inserting stem 204 into an aperture of second member 300. Second member 300 is used as a handle to guide a portion of first member 200 into ground 600, in step 704. Step 706 involves securing second member 300 into ground. In an example of step 706, protrusions (e.g., protrusions 304a and 304b) are transfixed into ground 600. Step 708 is optional. In step 708, anchoring system 100 may be locked, e.g., by insertion of lock 350 through a locking orifice 206 located above second member 300.

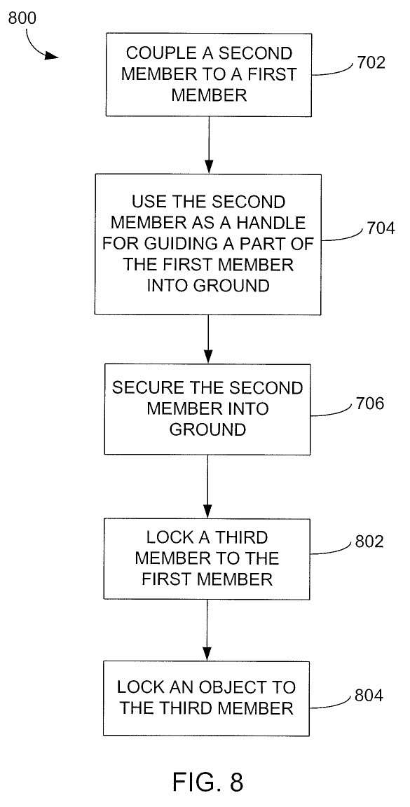

FIG. 8 shows a method 800 for locking an object 500 to anchoring system 100 using third member 400. Method 800 starts with step 702. In step 702 second member 300 is coupled to first member 200 by inserting stem 204 into an aperture of second member 300. Second member 300 may then be used as a handle to guide a portion of first member 200 into ground 600, in step 704. Step 706 involves securing second member 300 into ground 600. In an example of step 706, protrusions (e.g., protrusions 304a and 304b) are transfixed into ground 600. In step 802 a third member 400 is locked to first member 200. Method 800 ends with step 804. In step 804 object 500 is locked to third member 400.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present methods and systems, which, as a matter of language, might be said to fall there between.

What is claimed is:

1. An anchoring system, comprising:
a first member including:
a stem; and
a helix fixedly attached to the stem, the helix configured to penetrate and lodge into ground; and
a second member for coupling to the first member and securing the anchoring system into the ground.

2. The system of claim 1, wherein the stem comprises one or more locking orifices.

3. The system of claim 1, wherein the second member comprises a horizontal bar having at least one protrusion disposed substantially perpendicularly to the horizontal bar.

4. The system of claim 3, further comprising at least one strap attached to the horizontal bar for assisting with removal of the second member from ground.

5. The system of claim 3, wherein the horizontal bar forms an aperture configured for receiving the stem of the first member.

6. The system of claim 5, further comprising grips disposed on opposing sides of the aperture.

7. The system of claim 1, wherein the anchoring system components are fabricated from one or more materials selected from metals, metal alloys, plastics, rubber, carbon fiber, wood, ceramics and combinations thereof.

8. The system of claim 1, further comprising a third member for attaching to the stem of the first member.

9. The system of claim 8, wherein the third member comprises:
a body; and
at least one attachment fixture for securing an object to the third member.

10. The system of claim 9, wherein the attachment fixture is selected from the group consisting of a ball hitch, a ring, a chain and an attachment orifice.

11. The system of claim 9, wherein the body of the third member is integrally formed with a locking mechanism.

12. The system of claim 11, wherein the locking mechanism is a cylinder lock.

13. A method for installing an anchoring system, comprising:
coupling a second member to a first member;
using the second member as a handle for guiding a portion of the first member into ground; and
securing the second member into the ground.

14. The method of claim 13, wherein the first member comprises a locking orifice formed therein.

15. The method of claim 14, further comprising inserting a lock into the locking orifice after the second member is secured into the ground.

16. A method for locking an object to an anchoring system, comprising:
coupling a second member to a first member having at least one locking orifice;
using the second member as a handle for guiding a portion of the first member into ground;
securing the second member into the ground;
locking a third member to the at least one locking orifice of the first member; and
locking an object to the third member.

17. The method of claim 16, wherein the step of locking the object to the third member comprises securing the object to an attachment fixture of the third member.

18. The method of claim 17, wherein the attachment fixture is selected from the group consisting of a ball hitch, a ring, a chain and an attachment orifice.

19. The system of claim 17, wherein the step of locking the object to the third member comprises utilizing a locking mechanism that is integrally formed with a body of the third member to secure the object thereto.

20. The method of claim 19, wherein the locking mechanism is a cylinder lock.
